(19) United States
(12) Patent Application Publication
(10) Pub. No.: US 2026/0140293 A1
(43) Pub. Date: May 21, 2026

(54) LIQUID CRYSTAL OPTICAL ELEMENT

(71) Applicant: Japan Display Inc., Tokyo (JP)

(72) Inventors: Ayaka HIGUCHI, Tokyo (JP); Koichi IGETA, Tokyo (JP)

(73) Assignee: Japan Display Inc., Tokyo (JP)

(21) Appl. No.: 19/396,453

(22) Filed: Nov. 21, 2025

(30) Foreign Application Priority Data
Nov. 21, 2024 (JP) 2024-203340

(51) Int. Cl. G02B 5/30

(52) U.S. Cl. CPC G02B 5/3016

(57) ABSTRACT

According to one embodiment, a liquid crystal optical element includes a substrate having a main surface, a first liquid crystal film provided on the main surface, having a first side surface and including a first cholesteric liquid crystal, a second liquid crystal film overlapping the first liquid crystal film, having a second side surface and including a second cholesteric liquid crystal, and a fixing member formed in a frame shape surrounding the first liquid crystal film and the second liquid crystal film, contacting the substrate, the first side surface, and the second side surface and fixing the first liquid crystal film and the second liquid crystal film to the substrate.

### CROSS-REFERENCE TO RELATED APPLICATION

This application is based upon and claims the benefit of priority from Japanese Patent Application No. 2024-203340, filed Nov. 21, 2024, the entire contents of which are incorporated herein by reference.

### FIELD

Embodiments described herein relate generally to a liquid crystal optical element.

### BACKGROUND

For example, liquid crystal optical elements in which a plurality of liquid crystal layers are bonded together by an adhesive layer has been proposed. In this liquid crystal optical element, a first substrate comprises a first liquid crystal layer having a first cholesteric liquid crystal on a first alignment film, a second substrate comprises a second liquid crystal layer having a second cholesteric liquid crystal on a second alignment film, and an adhesive layer bonds the first substrate and the second substrate together.

On the other hand, a technique has been considered where a liquid crystal film is formed on a support substrate, then is stripped from the support substrate, and is transferred onto a desired substrate. This technique demands suppressing stripping of the transferred liquid crystal film from the substrate.

### BRIEF DESCRIPTION OF THE DRAWINGS

FIG. 1 is a cross-sectional view showing a configuration example of a liquid crystal optical element 100.

FIG. 2 is a plan view of the liquid crystal optical element 100 shown in FIG. 1.

FIG. 3 is a view for describing an example of the combination of a liquid crystal film 1 and a liquid crystal film 2.

FIG. 4 is a view for describing another example of the combination of the liquid crystal film 1 and the liquid crystal film 2.

FIG. 5 is a cross-sectional view for describing an example of cholesteric liquid crystals CL1 contained in the liquid crystal film 1.

FIG. 6 is a plan view schematically showing the liquid crystal film 1.

FIG. 7 is a cross-sectional view showing another configuration example of the liquid crystal optical element 100.

FIG. 8 is a cross-sectional view showing another configuration example of the liquid crystal optical element 100.

FIG. 9 is a cross-sectional view showing another configuration example of the liquid crystal optical element 100.

FIG. 10 is a cross-sectional view showing another configuration example of the liquid crystal optical element 100.

FIG. 11 is a cross-sectional view showing another configuration example of the liquid crystal optical element 100.

FIG. 12 is a cross-sectional view showing another configuration example of the liquid crystal optical element 100.

FIG. 13 is a cross-sectional view showing another configuration example of the liquid crystal optical element 100.

FIG. 14 is a cross-sectional view showing another configuration example of the liquid crystal optical element 100.

### DETAILED DESCRIPTION

Embodiments described herein aim to provide a liquid crystal optical element capable of suppressing stripping of a liquid crystal film.

In general, according to one embodiment, a liquid crystal optical element includes a substrate having a main surface, a first liquid crystal film provided on the main surface, having a first side surface and including a first cholesteric liquid crystal, a second liquid crystal film overlapping the first liquid crystal film, having a second side surface and including a second cholesteric liquid crystal, and a fixing member formed in a frame shape surrounding the first liquid crystal film and the second liquid crystal film, contacting the substrate, the first side surface, and the second side surface and fixing the first liquid crystal film and the second liquid crystal film to the substrate.

Embodiments will be described hereinafter with reference to the accompanying drawings.

The disclosure is merely an example, and proper changes in keeping with the spirit of the disclosure, which are easily conceivable by a person of ordinary skill in the art, come within the scope of the disclosure as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the disclosure. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z. A plane defined by the first direction X and the second direction Y is referred to as an X-Y plane. A plane defined by the second direction Y and the third direction Z is referred to as a Y-Z plane. A plane defined by the first direction X and the third direction Z is referred to as an X-Z plane. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them.

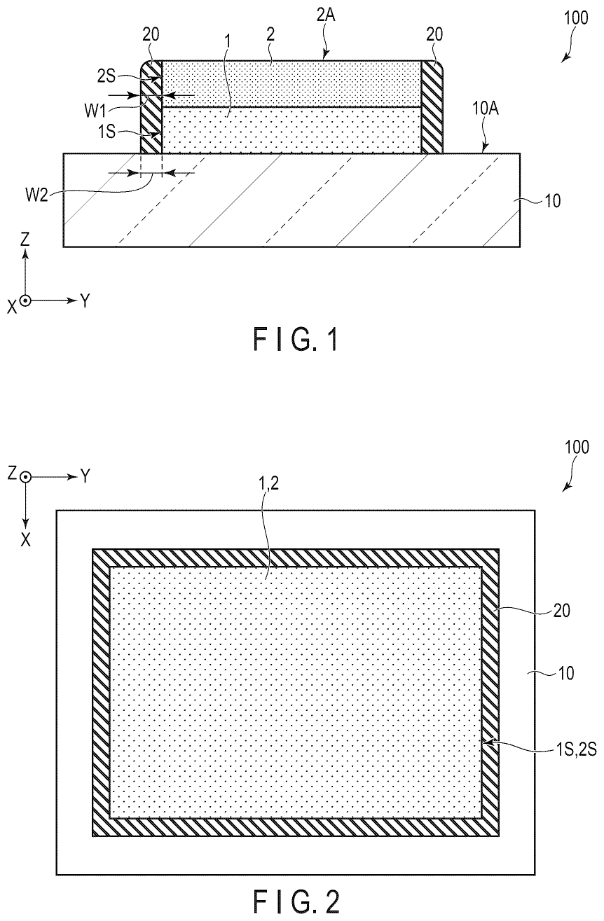

FIG. 1 is a cross-sectional view showing a configuration example of a liquid crystal optical element 100.

The liquid crystal optical element 100 comprises a substrate 10, a liquid crystal film 1, a liquid crystal film 2, and a fixing member 20.

For example, the substrate 10 is a transparent substrate such as a glass substrate and a synthetic resin plate. The substrate 10 may be a non-transparent substrate such as a silicon substrate and a metal substrate. This configuration will be described in detail later. The substrate 10 is formed in a flat plate shape and has a main surface 10A. The main surface 10A is a plane substantially parallel to the X-Y plane.

The liquid crystal film 1 is provided on the main surface 10A and has a side surface 1S. In the illustrated example, the liquid crystal film 1 contacts the main surface 10A. No alignment film or adhesive layer is interposed between the substrate 10 and the liquid crystal film 1. The side surface 1S has a plane substantially parallel to the X-Z plane.

The liquid crystal film 2 overlaps the liquid crystal film 1. In the third direction Z, the liquid crystal film 1 is located between the substrate 10 and the liquid crystal film 2. In the illustrated example, the liquid crystal film 2 contacts the liquid crystal film 1. No adhesive layer is interposed between the liquid crystal films 1 and 2.

Furthermore, the liquid crystal film 2 has an upper surface 2A and a side surface 2S. The upper surface 2A is opposite to the side facing the liquid crystal film 1 in the liquid crystal film 2 and is a plane substantially parallel to the X-Y plane. The side surface 2S has a plane substantially parallel to the X-Z plane. When the liquid crystal films 1 and 2 have the same shape, the side surface 2S is located directly above the side surface 1S in the third direction Z.

The fixing member 20 continuously contacts the main surface 10A of the substrate 10, the side surface 1S of the liquid crystal film 1, and the side surface 2S of the liquid crystal film 2, and fixes the liquid crystal films 1 and 2 to the substrate 10. In the illustrated example, the fixing member 20 does not cover the upper surface 2A.

The fixing member 20 has a first width W1 at a part contacting the side surface 2S in the direction parallel to the main surface 10A (or in the second direction Y). Further, the fixing member 20 has a second width W2 at a part contacting the main surface 10A. In the illustrated example, the first width W1 and the second width W2 are substantially equivalent to each other.

FIG. 2 is a plan view of the liquid crystal optical element 100 shown in FIG. 1.

In the illustrated example, each of the substrate 10 and the liquid crystal films 1 and 2 has a rectangular planar shape and has a pair of sides extending in the first direction X and a pair of sides extending in the second direction Y. Each of the substrate 10 and the liquid crystal films 1 and 2 may have other planar shapes such as other polygonal shapes, a circular shape, and an elliptic shape. Each of the side surfaces 1S and 2S extends along four sides. That is, each of the side surfaces 1S and 2S has a plane substantially parallel to the Y-Z plane, in addition to a plane substantially parallel to the X-Z plane. The fixing member 20 is formed in a frame shape surrounding the liquid crystal films 1 and 2 and contacts the entire sides surfaces 1S and 2S each extending along the four sides. The fixing member 20 is not limited to the illustrated closed state. A part of the fixing member 20 may be non-continuous.

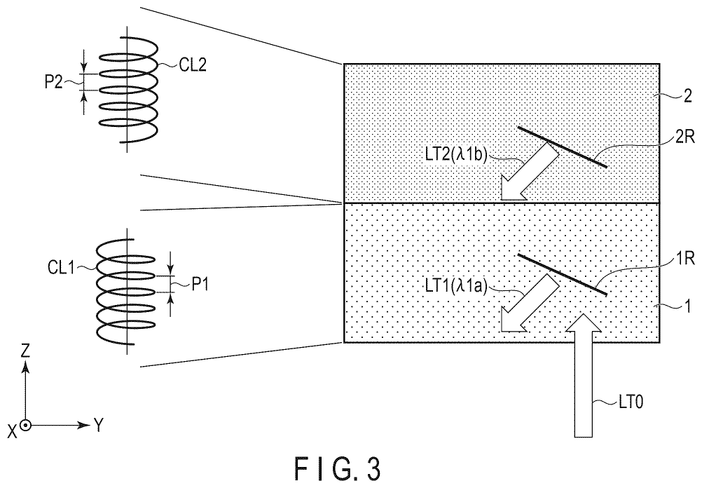

FIG. 3 is a view for describing an example of the combination of the liquid crystal film 1 and the liquid crystal film 2.

The liquid crystal film 1 has a cholesteric liquid crystal CL1 as schematically shown in the enlarged view. The cholesteric liquid crystal CL1 has a helical pitch P1 in the third direction Z. The helical pitch indicates one period of the helix (in other words, the layer thickness in the third direction Z required for a 360-degree rotation of the liquid crystal molecule).

The liquid crystal film 2 has a cholesteric liquid crystal CL2 as schematically shown in the enlarged view. The cholesteric liquid crystal CL2 has a helical pitch P2 in the third direction Z. For example, the helical pitches P1 and P2 are equivalent to each other. The rotational direction of the cholesteric liquid crystal CL2 differs from that of the cholesteric liquid crystal CL1.

Each of the liquid crystal films 1 and 2 is configured to reflect, of incident light, circularly polarized light having a selective reflection band determined based on the helical pitch P and the refractive anisotropy Δn of the liquid crystal film. In this specification, reflection in the liquid crystal film is accompanied by diffraction inside the liquid crystal film.

The liquid crystal film 1 has a reflective surface 1R reflecting circularly polarized light corresponding to the rotational direction of the cholesteric liquid crystal CL1 in the selective reflection band. The liquid crystal film 2 has a reflective surface 2R reflecting circularly polarized light corresponding to the rotational direction of the cholesteric liquid crystal CL2 in the selective reflection band. In the illustrated example, each of the reflective surfaces 1R and 2R inclines with respect to the X-Y plane. In this specification, circularly polarized light may be strict circularly polarized light or may be circularly polarized light which approximates elliptically polarized light.

For example, when a light LT0, which is natural light, enters the liquid crystal films 1 and 2, the liquid crystal film 1 reflects a light LT1 at the reflective surface 1R and the liquid crystal film 2 reflects a light LT2 at the reflective surface 2R. As described above, the helical pitches P1 and P2 are equivalent to each other. Thus, the light LT1 and the light LT2 are light of the same wavelength band λ1. Furthermore, the rotational directions of the cholesteric liquid crystal CL1 and CL2 differ from each other. Thus, the light LT1 and the light LT2 are circularly polarized in opposite directions. For example, the light LT1 is a right-handed circularly polarized light λ1a, and the light LT2 is a left-handed circularly polarized light λ1b.

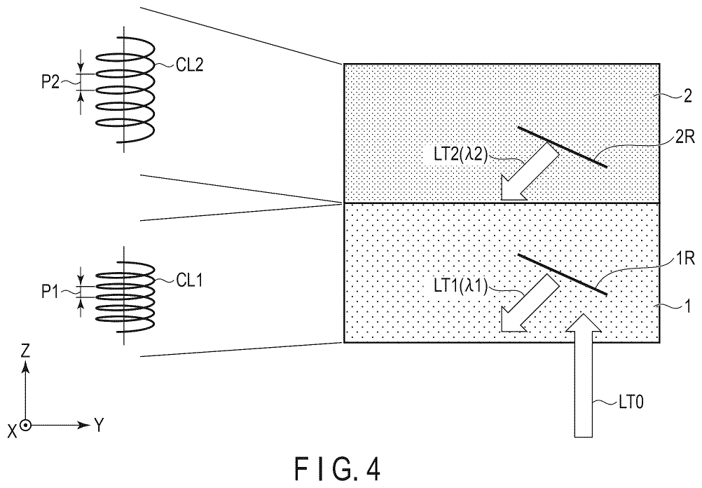

FIG. 4 is a view for describing another example of the combination of the liquid crystal film 1 and the liquid crystal film 2.

The example shown in FIG. 4 differs from the example shown in FIG. 3 in that the helical pitch P2 differs from the helical pitch P1. In the illustrated example, the helical pitch P2 is greater than the helical pitch P1. In the illustrated example, the cholesteric liquid crystals CL1 and CL2 have the same rotational direction. They may have different rotational directions.

For example, when the light LT0, which is natural light, enters the liquid crystal films 1 and 2, the liquid crystal film 1 reflects the light LT1 at the reflective surface 1R and the liquid crystal film 2 reflects the light LT2 at the reflective surface 2R. As described above, the helical pitches P1 and P2 are different from each other. Thus, the light LT1 and the light LT2 are light of different wavelength bands. When the helical pitch P2 is greater than the helical pitch P1, the wavelength band λ2 of the light LT2 reflected at the reflective surface 2R is in a longer wavelength band than the wavelength band λ1 of the light LT1 reflected at the reflective surface 1R.

In the illustrated example, the cholesteric liquid crystals CL1 and CL2 have the same rotational direction. Thus, the light LT1 and the light LT2 are circularly polarized light rotating in the same direction.

Next, the following will describe the configuration of the liquid crystal film. The following will describe the liquid crystal film 1. Except the rotational direction and the helical pitch, the liquid crystal films 1 and 2 have the same configuration.

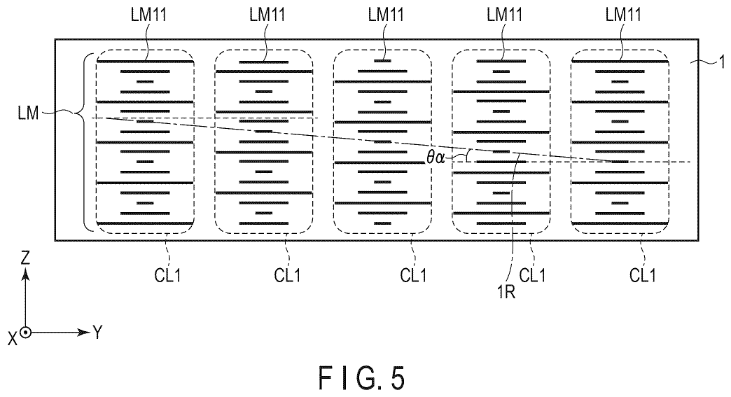

FIG. 5 is a cross-sectional view for describing an example of the cholesteric liquid crystals CL1 contained in the liquid crystal film 1.

FIG. 5 shows the liquid crystal film 1 enlarged in the third direction Z. In addition, to simplify the illustration, FIG. 5 shows one liquid crystal molecule LM among the liquid crystal molecules located on the same plane parallel to the X-Y plane as the liquid crystal molecules constituting each cholesteric liquid crystal CL1. The alignment direction of each liquid crystal molecule LM shown in the figure corresponds to the average alignment direction of the liquid crystal molecules located in the same plane.

When one of the cholesteric liquid crystals CL1 surrounded by broken lines is particularly looked at, the cholesteric liquid crystal CL consists of a plurality of liquid crystal molecules LM helically stacked in the third direction Z while twisting.

The alignment directions of the cholesteric liquid crystals CL1 adjacent to each other in the second direction Y differ from each other. In a plurality of cholesteric liquid crystals CL1 adjacent to each other in the second direction Y, the alignment directions of the liquid crystal molecules LM11 located in the same plane differ from each other. The alignment directions of the plurality of liquid crystal molecules LM11 continuously change in the second direction Y.

The reflective surface 1R of the liquid crystal film 1 shown by the one-dot chain line in the figure inclines with respect to the X-Y plane. The angle θα between the reflective surface 1R and the X-Y plane is an acute angle. The reflective surface 1R corresponds to a surface in which the alignment directions of the liquid crystal molecules LM are uniform, or a surface (an equiphase wave surface) in which the spatial phase is uniform.

This liquid crystal film 1 is cured in a state where the alignment directions of the liquid crystal molecules LM are fixed. That is, unlike those of general liquid crystal elements, the alignment directions of the liquid crystal molecules LM are not controlled by an electric field.

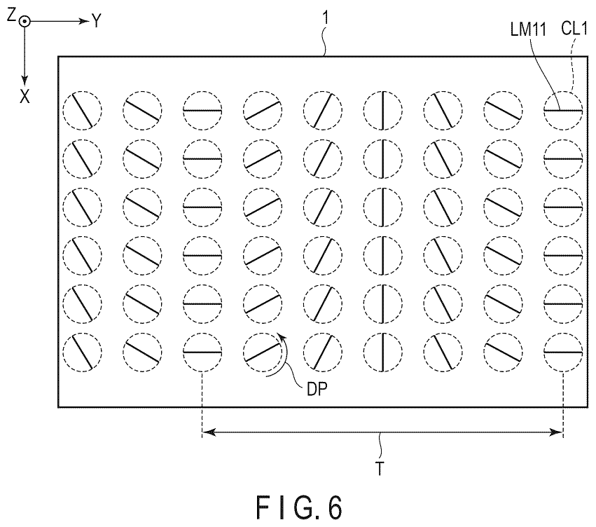

FIG. 6 is a plan view schematically showing the liquid crystal film 1.

FIG. 6 shows an example of the spatial phases of the cholesteric liquid crystals CL1. Here, the spatial phases are shown as the alignment directions of the liquid crystal molecules LM11 contained in the cholesteric liquid crystals CL1 indicated by the dashed circle.

In the cholesteric liquid crystals CL1 arranged in the second direction Y, the alignment directions of the liquid crystal molecules LM11 differ from each other. That is, the spatial phases of the cholesteric liquid crystals CL1 differ in the second direction Y.

In contrast, in the cholesteric liquid crystals CL1 arranged in the first direction X, the alignment directions of the liquid crystal molecules LM11 are substantially equivalent to each other. That is, the spatial phases of the cholesteric liquid crystals CL1 are substantially equivalent to each other in the first direction X.

In particular, regarding the cholesteric liquid crystals CL1 arranged in the second direction Y, the alignment direction varies with each liquid crystal molecule LM11 by a certain degree. That is, the alignment direction linearly varies with the liquid crystal molecules LM11 arranged in the second direction Y. Thus, the spatial phase linearly varies in the second direction Y with the cholesteric liquid crystals CL1 arranged in the second direction Y. Thus, as shown in FIG. 5, the reflective surface 1R inclined with respect to the X-Y plane is formed. Here, the phrase “linearly vary” means that, for example, the amount of variation in the alignment directions of the liquid crystal molecules LM11 is shown by a linear function. Here, the alignment direction of each liquid crystal molecule LM11 corresponds to the long axis direction of the liquid crystal molecule LM11 in the X-Y plane.

Here, a period T signifies the interval between two liquid crystal molecules LM11 when the alignment directions of the liquid crystal molecules LM11 vary by 180 degrees in the second direction Y on the same plane. In FIG. 6, DP indicates the rotational direction of the cholesteric liquid crystal CL1. The inclination angle θα of the reflective surface 1R shown in FIG. 5 is arbitrarily set based on the period T and the helical pitch P.

The following will briefly describe the manufacturing method of the liquid crystal optical element 100.

First, the liquid crystal films 1 and 2 are prepared. Specifically, an alignment film is formed on a support substrate. The alignment film has an alignment axis of a prescribed alignment pattern. Thereafter, liquid crystal materials are applied on the alignment film. The liquid crystal molecules contained in the liquid crystal materials are arranged in a helical shape by an alignment restriction force of the alignment film. The liquid crystal materials are cured with the liquid crystal molecules in a cholesteric liquid crystal phase. Thus, a liquid crystal film is formed. The liquid crystal film formed in this manner is stripped from the alignment film.

Next, the liquid crystal film 1 prepared in the above method is provided on the substrate 10. Further, the liquid crystal film 2 is provided on the liquid crystal film 1.

Next, the fixing member 20 surrounding the liquid crystal films 1 and 2 is formed. The fixing member 20 may be a preformed adhesive tape, a liquid adhesive that has been applied and then cured, or a material deposited using a method such as Chemical Vapor Deposition (CVD). Thus, the fixing member 20 closely adheres to the substrate 10 and the liquid crystal films 1 and 2. This fixing member 20 fixes the liquid crystal films 1 and 2 to the substrate 10.

Thus, stripping of the liquid crystal films 1 and 2 from the substrate 10 can be suppressed in the liquid crystal optical element 100 manufactured by transferring the separately formed liquid crystal films 1 and 2 onto the desired substrate 10. Thus, the quality and the reliability of the liquid crystal optical element 100 can be increased.

Here, the following lists some examples of materials applicable as the fixing member 20.

The following resin materials are applicable for the fixing member 20: acrylic resin, vinyl chloride, polyethylene terephthalate, polycarbonate resin, polyvinyl alcohol, polyethylene, uniaxially stretched polypropylene, biaxially stretched polypropylene, biaxially stretched polystyrene, polyvinylidene chloride, triacetyl cellulose, polycarbonate, polyether sulfone, polyphenyl sulfide, polyimide, polyurethane, fluororesin, norbornene resin, and cycloolefin resin materials.

Furthermore, silicon compounds such as a silicon nitride and a silicon oxide are also applicable for the fixing member 20.

Now, the following will describe another configuration example. The same constituent elements as in the above configuration example are denoted by the same reference numerals and their overlapping explanations are omitted in some cases.

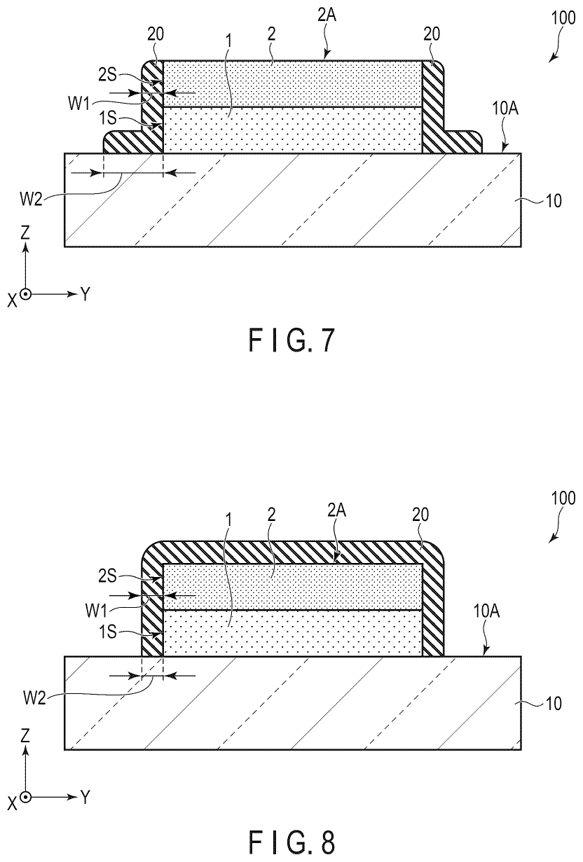

FIG. 7 is a cross-sectional view showing another configuration example of the liquid crystal optical element 100.

The configuration example shown in FIG. 7 differs from the configuration example shown in FIG. 1 in that the second width W2 is greater than the first width W1. That is, the fixing member 20 continuously extends from the side surface 2S toward the side surface 1S, further extends from the side surface 1S toward the main surface 10A, and contacts the main surface 10A. In the Y-Z cross section of the illustrated liquid crystal optical element 100, the second width W2 in the second direction Y of a part contacting the main surface 10A of the fixing member 20 is greater than the first width W1 in the second direction Y of a part contacting the side surface 2S of the fixing member 20. Though the illustration is omitted, the second width W2 is greater than the first width W1 in the X-Z cross section as well.

Thus, the contact area between the fixing member 20 and the substrate 10 is expanded. Thus, the liquid crystal films 1 and 2 can be fixed to the substrate 10 more firmly.

FIG. 8 is a cross-sectional view showing another configuration example of the liquid crystal optical element 100.

The configuration example shown in FIG. 8 differs from the configuration example shown in FIG. 1 in that the fixing member 20 continuously extends from the side surface 2S of the liquid crystal film 2 toward the upper surface 2A and covers the upper surface 2A. That is, the fixing member 20 covers the entire stacked layer bodies of the liquid crystal films 1 and 2 and contacts the substrate 10.

Thus, in addition to the same effects as those of the configuration example shown in FIG. 1, the liquid crystal film 2 can be protected. Thus, the quality and the reliability of the liquid crystal optical element 100 can be further increased.

To suppress undesirable light absorption and reflection by the fixing member 20, the fixing member 20 is preferably transparent and the fixing member 20 and the liquid crystal film 2 preferably have almost equivalent refractive indexes in the liquid crystal optical element 100 in which light passes through the fixing member 20. For example, the refractive index of the fixing member 20 is 1.5 to 1.7.

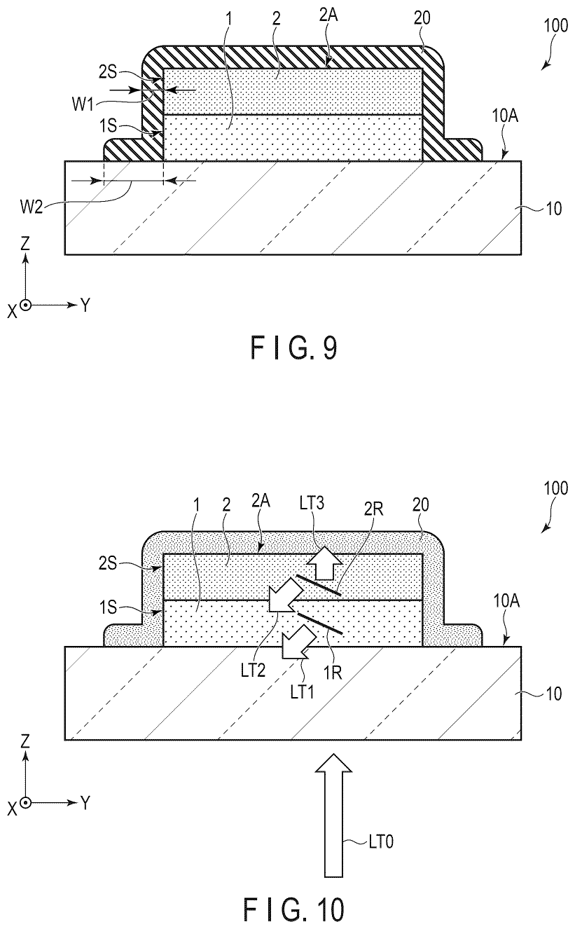

FIG. 9 is a cross-sectional view showing another configuration example of the liquid crystal optical element 100.

The configuration example shown in FIG. 9 differs from the configuration example shown in FIG. 8 in that the second width W2 is greater than the first width W1.

Thus, in addition to the same effects as those of the configuration example shown in FIG. 8, the contact area between the fixed member 20 and the substrate 10 can be expanded, and thus the liquid crystal films 1 and 2 can be more firmly fixed to the substrate 10.

In the configuration example shown in FIG. 9, both the substrate 10 and the fixing member 20 are transparent. Thus, each of the liquid crystal films 1 and 2 can reflect part of light entering through the substrate 10 and part of light entering through the fixing member 20, respectively.

FIG. 10 is a cross-sectional view showing another configuration example of the liquid crystal optical element 100.

The configuration example shown in FIG. 10 differs from the configuration example shown in FIG. 9 in that the transparent substrate 10 is transparent but the fixing member 20 is non-transparent.

In this liquid crystal optical element 100, when the light LT0 enters through the substrate 10, the liquid crystal film 1 is configured to reflect the light LT1 at the reflective surface 1R, and the liquid crystal film 2 is configured to reflect the light LT2 at the reflective surface 2R. In cases where the fixing member 20 is formed of a black material, a light LT3 transmitted through the liquid crystal films 1 and 2 is absorbed by the fixing member 20.

Thus, in addition to the same effects as those of the configuration example shown in FIG. 9, the generation of undesirable reflected light within the liquid crystal optical element 100 can be suppressed.

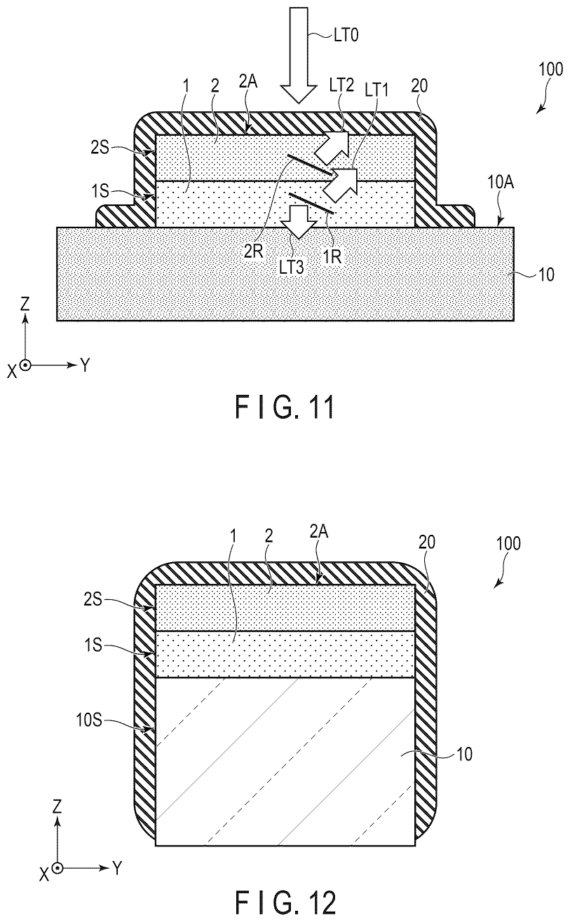

FIG. 11 is a cross-sectional view showing another configuration example of the liquid crystal optical element 100.

The configuration example shown in FIG. 11 differs from the configuration example shown in FIG. 9 in that the fixing member 20 is transparent but the substrate 10 is non-transparent.

In this liquid crystal optical element 100, when the light LT0 enters through the fixing member 20, the liquid crystal film 2 is configured to reflect the light LT2 at the reflective surface 2R, and the liquid crystal film 1 is configured to reflect the light LT1 at the reflective surface 1R. In cases where the substrate 10 is formed of a black material, the light LT3 transmitted through the liquid crystal films 1 and 2 is absorbed by the substrate 10.

Thus, in addition to the same effects as those of the configuration example shown in FIG. 9, the generation of undesirable reflected light within the liquid crystal optical element 100 can be suppressed.

FIG. 12 is a cross-sectional view showing another configuration example of the liquid crystal optical element 100.

The configuration example shown in FIG. 12 differs from the configuration example shown in FIG. 8 in that the fixing member 20 contacts the side surface 10S of the substrate 10. The substrate 10, the liquid crystal film 1, and the liquid crystal film 2 all have the same planar shape. The side surface 1S of the liquid crystal film 1 and the side surface 2S of the liquid crystal film 2 are located directly above the side surface 10S of the substrate 10 in the third direction Z. The fixing member 20 continuously covers the side surface 10S, the side surface 1S, the side surface 2S, and the upper surface 2A.

The thickness of the substrate 10 in the third direction Z is greater than the thickness of both the liquid crystal films 1 and 2 in the third direction Z. In one example, the thickness of each of the liquid crystal films 1 and 2 is several μm, and the thickness of the substrate 10 is several hundred μm or more. Thus, the contact area between the side surface 10S of the substrate 10 and the fixing member 20 is greater than the contact area between the side surface 1S of the liquid crystal film 1 and the fixing member 20 and is also greater than the contact area between the side surface 2S of the liquid crystal film 2 and the fixing member 20.

Thus, in addition to the same effects as those of the configuration example shown in FIG. 8, the contact area between the fixed member 20 and the substrate 10 can be expanded, and thus the liquid crystal films 1 and 2 can be more firmly fixed to the substrate 10.

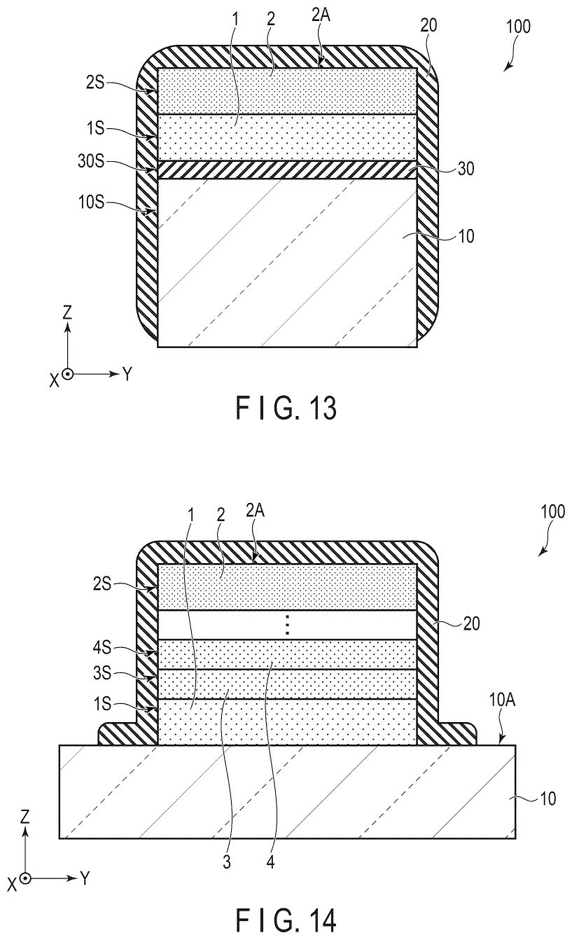

FIG. 13 is a cross-sectional view showing another configuration example of the liquid crystal optical element 100.

The configuration example shown in FIG. 13 differs from the configuration example shown in FIG. 12 in that an alignment film 30 is provided between the substrate 10 and the liquid crystal film 1. The fixing member 20 contacts a side surface 30S of the alignment film 30.

In this configuration example as well, the same effects as those of the configuration example shown in FIG. 12 are obtained.

FIG. 14 is a cross-sectional view showing another configuration example of the liquid crystal optical element 100.

The configuration example shown in FIG. 14 differs from the configuration example shown in FIG. 9 in that the liquid crystal optical element 100 comprises three or more stacked layer bodies of the liquid crystal film. When a plurality of liquid crystal films are stacked, the liquid crystal film 1 is located at the bottom layer of the stacked layer body, the liquid crystal film 2 is located at the top layer of the stacked layer body, and other liquid crystal films 3, 4, . . . are located between the liquid crystal films 1 and 2. In the illustrated example, the liquid crystal film 1 contacts the substrate 10. Further, the liquid crystal film 2 is covered with the fixing member 20. No adhesive layer is interposed between the two liquid crystal films.

In one example, the liquid crystal film 1 is configured to reflect circularly polarized light in the blue wavelength band as its selective reflection band, the liquid crystal film 2 is configured to reflect circularly polarized light in the green wavelength band as its selective reflection band, and the liquid crystal film 3 is configured to reflect circularly polarized light in the red wavelength band as its selective reflection band.

This example of the liquid crystal optical element 100 can broaden the selective reflection band.

In another example, the liquid crystal film 1 is configured to reflect right-handed circularly polarized light in the blue wavelength area as its selective reflection band, the liquid crystal film 2 is configured to reflect right-handed circularly polarized light in the green wavelength area as its selective reflection band, the liquid crystal film 3 is configured to reflect right-handed circularly polarized light in the red wavelength band as its selective reflection band, the liquid crystal film 4 is configured to reflect left-handed circularly polarized light in the blue wavelength band as its selective reflection band, the liquid crystal film 5 is configured to reflect left-handed circularly polarized light in the green wavelength band as its selective reflection band, and the liquid crystal film 6 is configured to reflect right-handed circularly polarized light in the red wavelength band as its selective reflection band.

This example of the liquid crystal optical element 100 can reflect both right-handed circularly polarized light and left-handed circularly polarized light in the same wavelength band, thereby improving the light utilization efficiency.

In the above embodiment, for example, the liquid crystal film 1 corresponds to the first liquid crystal film, the cholesteric liquid crystal CL1 corresponds to the first cholesteric liquid crystal, and the side surface S1 corresponds to the first side surface. The liquid crystal film 2 corresponds to the second liquid crystal film, the cholesteric liquid crystal CL2 corresponds to the second cholesteric liquid crystal, and the side surface S2 corresponds to the second side surface.

As explained above, the embodiment can provide a liquid crystal optical element capable of suppressing stripping of the liquid crystal film.

While certain embodiments of the present disclosure have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is

1. A liquid crystal optical element comprising:
a substrate having a main surface;
a first liquid crystal film provided on the main surface, having a first side surface, and including a first cholesteric liquid crystal;
a second liquid crystal film overlapping the first liquid crystal film, having a second side surface, and including a second cholesteric liquid crystal; and
a fixing member formed in a frame shape surrounding the first liquid crystal film and the second liquid crystal film, contacting the substrate, the first side surface and the second side surface, and fixing the first liquid crystal film and the second liquid crystal film to the substrate.

2. The liquid crystal optical element of claim 1, wherein
a rotational direction of the first cholesteric liquid crystal is different from that of the second cholesteric liquid crystal.

3. The liquid crystal optical element of claim 1, wherein
a helical pitch of the first cholesteric liquid crystal is different from that of the second cholesteric liquid crystal.

4. The liquid crystal optical element of claim 1, wherein
the fixing member continuously extends from the first side surface toward the main surface and contacts the main surface.

5. The liquid crystal optical element of claim 4, wherein
the fixing member has a first width at a part contacting the second side surface in a direction parallel to the main surface and a second width at a part contacting the main surface, and
the second width is greater than the first width.

6. The liquid crystal optical element of claim 1, wherein
the second liquid crystal film has an upper surface on a side opposite to a side facing the first liquid crystal film, and
the fixing member continuously extends from the second side surface toward the upper surface and covers the upper surface.

7. The liquid crystal optical element of claim 6, wherein
the substrate is transparent.

8. The liquid crystal optical element of claim 7, wherein
the fixing member is non-transparent, and
each of the first liquid crystal film and the second liquid crystal film is configured to reflect part of light entering through the substrate.

9. The liquid crystal optical element of claim 6, wherein
the fixing member is transparent.

10. The liquid crystal optical element of claim 9, wherein
the substrate is non-transparent, and
each of the first liquid crystal film and the second liquid crystal film is configured to reflect part of light entering through the fixing member.

11. The liquid crystal optical element of claim 1, wherein
no alignment film is interposed between the substrate and the first liquid crystal film, and
no adhesive layer is interposed between the first liquid crystal film and the second liquid crystal film.

12. The liquid crystal optical element of claim 6, wherein
the fixing member contacts a side surface of the substrate.

13. The liquid crystal optical element of claim 6, further comprising:
an alignment film provided between the substrate and the first liquid crystal film, wherein
the fixing member contacts a side surface of the alignment film.

14. The liquid crystal optical element of claim 1, wherein
the fixing member is formed of a resin material.

15. The liquid crystal optical element of claim 1, wherein
the fixing member is formed of a silicon compound.
